(19) United States
(12) Patent Application Publication
(10) Pub. No.: US 2008/0014507 A1
(43) Pub. Date: Jan. 17, 2008

(54) High power high energy lithium-ion cell

(76) Inventor: Joseph B. Kejha, Meadowbrook, PA (US)

Correspondence Address: Zachary T. Wobensmith, III, 7746 101st Court, Vero Beach, FL, 32967-2871, US

(21) Appl. No.: 11/897,512

(22) Filed: Aug. 31, 2007

Related U.S. Application Data
(63) Continuation-in-part of application No. 11/487,495, filed on Jul. 17, 2006.

(51) Int. Cl. H01M 4/40; H01M 6/16

(52) U.S. Cl. 429/322; 429/231.95

(57) ABSTRACT

A high power high voltage lithium-ion cell, which includes an anode of lithium titanate (Li₄Ti₅0₁₂), a cathode of lithium nickel phosphate (LiNiPO₄), or of lithium manganese phosphate (LiMiPO₄), or of mixed phosphates of nickel, manganese and cobalt (LiNiMnCoPO₄), or their mixtures, and a non-aqueous liquid electrolyte. Both the anode and the cathode materials are preferably of nano-sized particles.

### CROSS REFERENCE TO RELATED APPLICATIONS

This application is a Continuation in part of my prior application Ser. No. 11/487/495, filed Jul. 17, 2006, entitled: “High Power High Voltage Lithium-Ion Cell.”

### BACKGROUND OF THE INVENTION

1. Field of the Invention

This invention relates to a high power high energy lithium-ion cell, which is of the type that has a lithium titanate anode, a liquid electrolyte, and a lithium nickel phosphate, or a lithium manganese phosphate cathode, or a cathode of a mixture of high voltage phosphates.

2. Description of the Prior Art

It is well known in the prior art that lithium titanate (Li₄Ti₅0₁₂) has excellent high rate capabilities (power), when used in lithium-ion batteries or in asymmetric capacitors. U.S. Pat. No. 5,766,796 discusses the use of lithium titanate as an anode, with a solid polymer electrolyte, and various cathodes, such as LiMn₂0₂, LiCoO₄, LiNi0₂, and LiV₂0₅ and their derivates. All of these electrochemical couples have a lower voltage span (1.5V-2.8V) than standard lithium-ion batteries (3.0V-4.2V) and also may have lower energy density.

It is therefore desirable to couple a lithium titanate anode with a high voltage cathode to obtain a lithium-ion cell with higher voltage and higher energy density.

Lithium nickel phosphate (LiNiP0₄) and lithium manganese phosphate (LiMnPO₄) are known as cathode materials with a high voltage potential of about 5 volts. Both have been tried as a cathode in lithium-ion cells coupled with anodes of graphite, MCMB, or lithium, however the cells failed due to the instability of the electrolyte, which oxidized due to the high voltage produced by these phosphate cathodes. In prior art U.S. Pat. Nos. 5,910,382 of Goodenough et al, and 6,514,640 B1 of Armand et al., Example 1 states, that Li extraction (cell testing), was not possible due to the voltage being above 4.3 volts. Therefore the use of these materials can not be claimed.

This invention of coupling a lithium titanate anode with a lithium nickel phosphate cathode, or a lithium manganese phosphate cathode, or a lithium cobalt phosphate cathode, causes a voltage reduction to approximately 3.5 volts, resulting in a voltage span of (1.5V to 3.5V), approximately. A liquid non-aqueous electrolyte of well-known type is used in the cell, and will not oxidize or decompose upon cycling.

### SUMMARY OF THE INVENTION

It has been found, that novel high power higher voltage lithium-ion cells can be produced by coupling a lithium titanate anode with a lithium nickel phosphate cathode, or a lithium manganese phosphate cathode, or a mixed nickel, manganese and cobalt phosphate cathode in the presence of a liquid electrolyte, and with a separator therebetween. Such cells also have a high recharge rate due to the lithium titanate anode.

The principal object of the invention is to provide a lithium-ion cell that has both high power, and high energy density, and a high rate of recharge.

A further object of the invention is to provide a lithium-ion cell that is simple and inexpensive to construct.

A further object of the invention is to provide a lithium-ion cell wherein the anode and the cathode are fabricated of nano-sized particles.

A further object of the invention is to provide a lithium-ion cell, which is durable and long lasting in service.

A further object of the invention is to provide a lithium-ion cell, which is suitable for use in hybrid electric vehicles (HEVs).

A further object of the invention is to provide a lithium-ion cell, which is particularly suitable for mass production.

Other objects and advantageous features of the invention will be apparent from the description and claims.

It should, of course, be understood that the description herein is merely illustrative, and that various modifications and changes can be made in the structures disclosed without departing from the spirit of the invention.

### DESCRIPTION OF THE PREFERRED EMBODIMENTS

When referring to the preferred embodiments, certain terminology will be utilized for the sake of clarity. Use of such terminology is intended to encompass not only the described embodiment, but also technical equivalents, which operate and function in substantially the same way to bring about the same result.

The lithium-ion cell of the invention can be of any desired configuration, in that it can be flat, such as described in my prior U.S. patent application Ser. No. 11/378,973 or it can be wound, as is well known in the prior art.

The cell includes a first layer (not shown), which may be an anode with a porous current collector (not shown) embedded in the middle of its active material and with a terminal (not shown) extending therefrom. The anode includes a lithiated titanium spinel (Li₄Ti₅0₁₂), which anode may be fabricated by the method as disclosed in U.S. Pat. No. 5,766,796 wherein the anode consists of lithiated titanium spinel, preferably of nano-sized particles mixed with a high surface area carbon (such as acetylene black) and a polymeric binder. Lithium titanate is especially suitable for high rate cell recharge, at low temperature, such as in a HEV battery. The anode has a metal current collector (not shown) with a terminal tab (not shown). A second layer (not shown) is provided on top of the first layer, which may be a microporous separator of polytetrafluorethylene, as manufactured by W.L. Gore & Assoc., Inc. Elkton, Md.

The electrolyte can be any suitable electrolyte, with a 1 Mol LiPF₆/EC/DMC/EMC electrolyte in a ratio of (1:1:1) being particularly suitable, where EC=Ethylene Carbonate, DMC=Dimethyl Carbonate, and EMC=Ethyl-Methyl Carbonate.

A third layer (not shown) is provided on top of the second layer, which layer is a cathode, and which has a metal grid current collector (not shown) embedded therein. The cathode contains lithium nickel phosphate (LiNiPO₄) or lithium manganese phosphate (LiNiPO₄), or a mixed nickel, manganese and cobalt phosphate (LiNiMnCoPO₄), or various mixtures of nickel, manganese, cobalt phosphates, and mixed nickel, manganese and cobalt phosphate, all of which are preferably of nano-sized particles which are preferably milled and mixed with electrically conductive carbon or other suitable materials, and which cathode also contains a polymeric binder of well known type. The nano-particles are defined as being smaller than one micron. The current collector (not shown) has a terminal tab (not shown) extending therefrom.

The cell (not shown) is preferably assembled as described in my prior U.S. patent application Ser. No. 11/378,973, by heat and pressure, with the various layers bonded together.

The cell (not shown) is then sealed in a suitable moisture proof enclosure (not shown).

The voltage of these new electrochemical couples (3.5V) is higher than the voltage of prior art couples, such as lithium titanate-lithium cobaltate; lithium titanate-lithium manganete; lithium titanate-lithium nickeltate; or lithium titanate-lithium vanadate, (2.8V), which increases the energy density of the high power and high recharge rate cells. The cobalt component in the mixed phosphates also provides for good stability upon cycling. The cost is reduced by less cobalt presence as % (percent) of weight of this material as compared to LiCo0₂. Therefore, a primary application of the described cell of the invention is for use in hybrid electric vehicles.

It will thus be seen that a lithium-ion cell has been provided with which the objects of the invention are achieved.

I claim:

1. A high power high voltage lithium-ion cell which comprises;
an anode which includes lithium titanate (Li₄Ti₅0₁₂),
a cathode which includes lithium nickel phosphate (LiNiPO₄),
a separator therebetween,
a non-aqueous electrolyte, and a moisture proof enclosure.

2. A high power high voltage lithium-ion cell which comprises;
an anode which includes lithium titanate (Li₄Ti₅0₁₂),
a cathode which includes lithium manganese phosphate (LiMnPO₄),
a separator therebetween,
a non-aqueous electrolyte, and a moisture proof enclosure.

3. A high power high voltage lithium-ion cell which comprises;
an anode which includes lithium titanate (Li₄Ti₅0₁₂),
a cathode which includes mixed lithium nickel, manganese and cobalt phosphate (LiNiMnCoPO₄),
a separator therebetween,
a non-aqueous electrolyte, and a moisture proof enclosure.

4. A high power high voltage lithium-ion cell which comprises;
an anode which includes lithium titanate (Li₄Ti₅0₁₂),
a cathode which includes a mixture selected from the group comprising:
lithium nickel phosphate (LiNiPO₄), lithium manganese phosphate (LiMnPO₄), lithium cobalt phosphate (LiCoPO₄) and mixed lithium nickel, manganese and cobalt phosphate (LiNiMnCoPO₄),
a separator therebetween,
a non-aqueous electrolyte, and a moisture proof enclosure.

5. A lithium-ion cell as defined in claims 1, or 2, or 3, or 4, in which said lithium titanate and said lithium metal phosphates are of nano-sized particles.

6. A lithium-ion cell as defined in claims 1, or 2, or 3, or 4 in which said electrolyte is one Mol LiPF₆/EC/DMC/EMC.

7. A lithium cell as defined in claim 6 which has a ratio of carbonates of (1:1:1).
